(19) United States
(12) Patent Application Publication
(10) Pub. No.: US 2006/0261566 A1
(43) Pub. Date: Nov. 23, 2006

(54) SPARE TIRE CONTAINER

(76) Inventors: James A. Mulvihill, Berkley, MI (US); Thomas S. Hicks, Livonia, MI (US); Jason T. Gamache, Romeo, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/908,595

(22) Filed: May 18, 2005

(51) Int. Cl. B62B 1/00

(52) U.S. Cl. 280/47.131; 280/79.4

(57) ABSTRACT

A spare tire container is provided that includes first and second housing portions hingedly connected to one another and a plurality of wheels rotatably coupled to one of the housing portions. Each housing portion includes a tire-receiving cavity formed therein. The first and second housing portions may be connected with a living hinge and integrally formed with the living hinge as a unitary construction using a blow molding process.

### FIELD OF THE INVENTION

The present invention relates to a vehicle storage container, and more particularly to a container for storage of a spare tire on a vehicle.

### BACKGROUND OF THE INVENTION

One definition of a wheel is a solid disk or a rigid circular ring connected by spokes to a hub, designed to turn around an axle passed through the center. A tire is a covering for a wheel usually made of rubber reinforced with cords of nylon, fiberglass, or other material and filled with compressed air. However, in the automotive art the combination of a wheel and tire is commonly referred to simply as a tire. Accordingly, as used herein, the term “tire” will refer to the combination of a vehicle wheel and tire, with a spare tire referring to a tire reserved for future use.

Over-the-road vehicles, including automobiles, trucks, sport utility vehicles, and recreational vehicles, typically carry one or more spare tires so the vehicle operator or passenger can replace a blown or flat tire occurring during a trip, thereby avoiding the expense and inconvenience of having the vehicle towed to a location where the tire can be replaced.

Historically, spare tires have been stored in the trunks of automobiles, while larger vehicles such as trucks and sport utility vehicles have often secured one or more spare tires to the undercarriage of the vehicle due to the lack of a trunk. With other vehicles, a spare tire may be stored within the interior of the vehicle at a location other than the trunk.

Many conventional means of storing a spare tire in a trunk of an automobile require the operator to grasp the spare tire and lift it out of the trunk, which can be somewhat awkward. The operator is then required to roll or carry the spare tire to the position of the blown or flat tire. This procedure can also be awkward and somewhat dangerous for the operator if done immediately adjacent a roadway.

Replacing a blown or flat tire at night can present additional problems. For instance, if done on the side of the vehicle adjacent the roadway, it may be difficult for other drivers to see the operator changing the tire, placing the operator at risk. Furthermore, the lack of proper lighting can complicate the task of changing the tire. For instance, a dropped lug nut may be difficult to locate without a light and vehicle operators may not remember to carry a flashlight or other light source in their vehicle.

Once the spare tire has been mounted, the operator must return the blown or flat tire to the trunk or other area of the vehicle. This may be particularly difficult if the condition of the tire prevents rolling and it must be carried to the trunk area or other area of the vehicle and lifted into the vehicle. The blown or flat tire may be dirty, crusty, fragmented, and wet, depending on weather and other conditions. Accordingly, placing the blown or flat tire into the interior of the vehicle, including the trunk, may cause undesirable soiling of the vehicle interior, or other damage.

In view of the foregoing, there is a continuing need for an improved device for carrying a spare tire on a vehicle.

### SUMMARY OF THE INVENTION

A first aspect of the present invention is directed to a spare tire container comprising first and second housing portions, with each having a tire-receiving cavity formed therein. The spare tire container further includes a plurality of wheels rotatably coupled to one of the first and second housing portions. In one embodiment a pair of wheels are utilized, while two pairs of wheels are utilized in another embodiment with one pair on each side of the container.

The spare tire container can also include one or more handles integrally formed with one of the first and second housing portions. The handle(s) makes it easier for the vehicle operator to lift the spare tire container out of its stowed location, typically the trunk of a vehicle, while the wheels allow the operator to effortlessly roll the container to the position of the blown or flat tire.

The first housing portion of the spare tire container is connected to the second housing portion and can be hingedly connected. In one embodiment, this is accomplished with a living hinge, with the first and second housing portions and the living hinge being formed as a unitary construction. In another embodiment, the first and second housing portions are separately formed and are connected by a mechanical hinge.

In the embodiment including a living hinge, the first and second housing portions and living hinge can be advantageously molded as a unitary construction and, even more advantageously molded by blow molding which is very cost effective.

The spare tire container can further include at least one reflector attached to an external surface of one of the housing portions. In this manner, the container is easier to see by other drivers at night, thereby increasing the safety of the operator during the tire changing process. Also, the spare tire container can include at least one lamp secured to one of the housing portions which can assist the operator by providing sufficient lighting during the tire changing process and can also help the operator to be seen by other drivers at night.

One or more implement-receiving cavities can be formed in at least one of the housing portions of the container. For instance, cavities can be formed that are effective for receiving a tire lug nut wrench, a jack, flares, a flashlight, and other items. This provides a convenient way of storing various items necessary to safely complete the installation of a spare tire.

A second aspect of the invention is directed to a method of manufacturing a spare tire container for use on a motor vehicle comprising the steps of forming first and second housing portions of the container, with each of the housing portions including tire-receiving cavities therein. The method further includes the steps of connecting the first and second housing portions to one another and rotatably coupling a plurality of wheels to one of the first and second housing portions.

The steps of forming the first and second housing portions may comprise the steps of blow molding the first and second housing portions. The step of connecting the first and second housing portions to one another can comprise the step of hingedly connecting these two portions and in one embodiment this can be accomplished with a living hinge. In this embodiment, the two housing portions and living hinge can advantageously be integrally formed with one another as a unitary construction.

The first and second cavities can be substantially cylindrical and the method can further include the step of forming at least one implement-receiving cavity in one of the first and second housing portions, at a position outward of the tire-receiving cavity formed within the respective housing portion. In another embodiment, method can include the step of forming a tool-receiving cavity and positioning it within the tire-receiving cavity formed in the respective housing portion. In either case, an economy of space is realized with the methodology of the present invention.

### BRIEF DESCRIPTION OF THE DRAWINGS

These and other features, aspects, and advantages of the present invention will become better understood with regard to the following description, appended claims and accompanying drawings wherein:

FIG. 1 is a perspective view of a spare tire container according to one embodiment of the present invention, with the container shown in an open position;

FIG. 2 is a perspective view of the spare tire container shown in FIG. 1, with the container shown in a closed position;

FIG. 3 is a perspective view of the lower portion of the spare tire container shown in FIG. 1, with the upper portion and living hinge removed for ease of illustration and a plurality of stored tools illustrated within the container;

FIG. 4 is a perspective view similar to FIG. 3 except with a spare tire illustrated within the container;

FIG. 5 is a cross-sectional view of a spare tire container according to an alternative embodiment of the present invention illustrating a container seal.

FIG. 6 is a fragmentary cross-sectional view, similar to a portion of FIG. 5, but illustrating a mechanical hinge of another alternative embodiment of the present invention in lieu of the living hinge shown in FIG. 1;

FIG. 7 is a fragmentary view partially in cross-section and partially in perspective illustrating a mechanical hinge of another alternative embodiment of the present invention in lieu of the living hinge shown in FIG. 1 and the mechanical hinge shown in FIG. 6;

FIG. 8A is a top perspective view of a lower portion of a spare tire container according to an alternative embodiment of the present invention, with the interior of the lower portion being illustrated; and

FIG. 8B is a bottom perspective view of the lower portion of the spare tire container shown in FIG. 8A.

### DETAILED DESCRIPTION

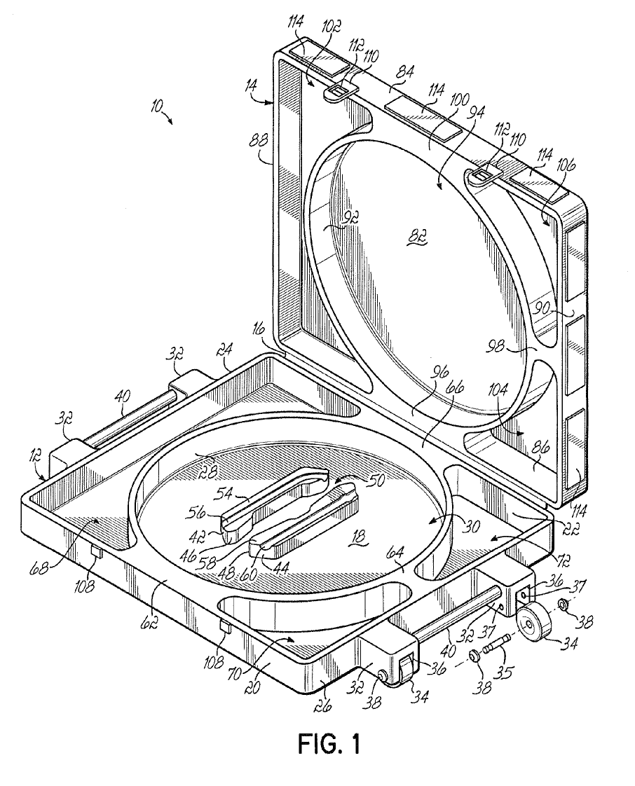

Referring now to the drawings, FIG. 1 is a perspective view illustrating a spare tire container 10. The spare tire container 10 includes a first housing portion 12 and a second housing portion 14. In the illustrative embodiment, the first housing portion 12 comprises a lower housing portion, while the second housing portion 14 comprises an upper housing portion. The first 12 and second 14 housing portions can be constructed by numerous thermoplastic manufacturing methods, including blow molding, vacuum forming, or injection molding. Blow molding is used in one preferred embodiment since it represents a cost efficient method of manufacturing and because of the strength resulting from the double wall construction which is inherent to a blow molding process.

In the illustrative embodiment, the first housing portion 12 is hingedly connected to the second housing portion 14 via a living hinge 16. A living hinge is a term of art in the blow molding industry and is understood to represent a pinched or flattened area that is relatively flexible and is utilized to interconnect one portion of a molded part to another. The two walls of the double wall construction are compressed together and thinned in the living hinge, as may be appreciated by one of ordinary skill in the art. In the illustrative embodiment, the first housing portion 12, second housing portion 14 and the living hinge 16 are formed as a unitary construction from a thermoplastic material, by blow molding.

The first or lower housing portion 12 includes a floor 18, a forward end 20, rear end 22 and a pair of sides 24, 26. As shown in FIG. 1, the front 20 and rear 22 ends and sides 24 and 26 are integral with and extend upwardly from the floor 18 of housing portion 12. The housing portion 12 may have a generally square shape, in which case the lengths of ends 20, 22 and sides 24, 26 are substantially the same. In other embodiments, the external shape of the housing portions 12, 14 can be rectangular or can be an irregular shape, within the scope of the present invention.

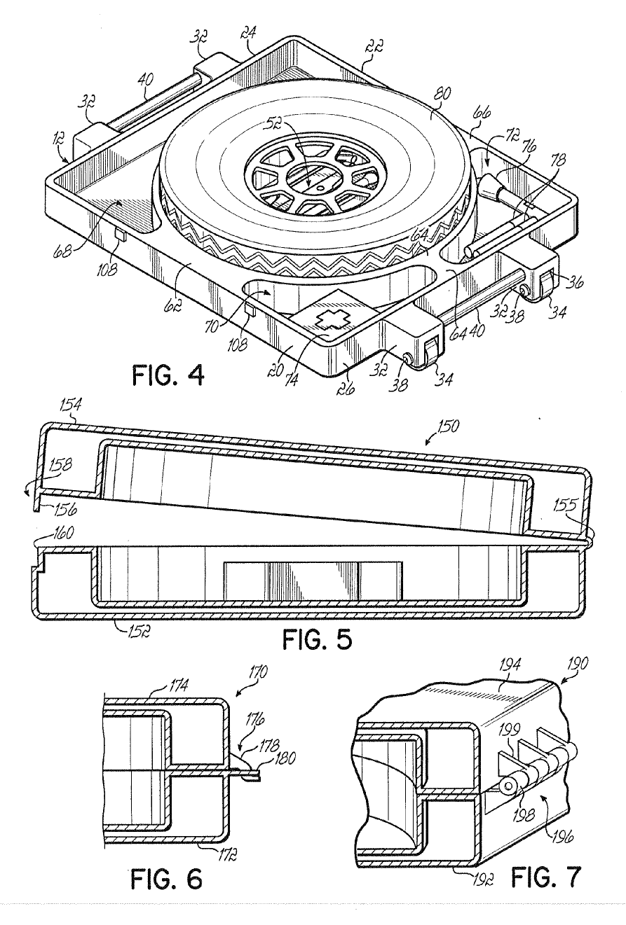

The first housing portion 12 further includes a substantially cylindrical rim 28 which extends upwardly from the floor 18. The floor 18 and rim 28 combine to define a first, substantially cylindrical tire-receiving cavity 30 within the first housing portion 12. As may be appreciated from FIG. 1, the cavity 30 is open ended at the top. Accordingly, as shown in FIG. 4, cavity 30 is effective for receiving a spare tire 80. The diameter of rim 28 is sized to accommodate a particular tire, depending on the vehicle on which container 10 will be carried. Consequently, cavity 30 accommodates the full circumferential extent of tire 80 but only a portion of the tread width of tire 80 due to the height of rim 28.

The spare tire container 10 further includes a plurality of lugs, or wheel housings 32 that are integrally formed with and extend outwardly from the first housing portion 12. Container 10 also includes a plurality of rotatable wheels 34, with each of the wheels 34 being rotatably coupled to one of the lugs 32. In the illustrative embodiment, each wheel 34 is disposed within a channel 36 formed in each of the lugs 32. The wheels 34 may be retained within cavities 36 and rotatably coupled to the lugs 32 by a wide variety of means. For example, in the illustrative embodiment, each lug 32 can include two holes 37, with each extending through a portion of lug 32 on one side of cavity 36. An axle 35 passes through one of the holes 37, through a hole formed in the center of wheel 34 and through the other hole 37. Axle 35 is retained by a pair of fasteners such as winch nuts 38 as illustrated in FIG. 1. Other conventional means may also be used as may be appreciated.

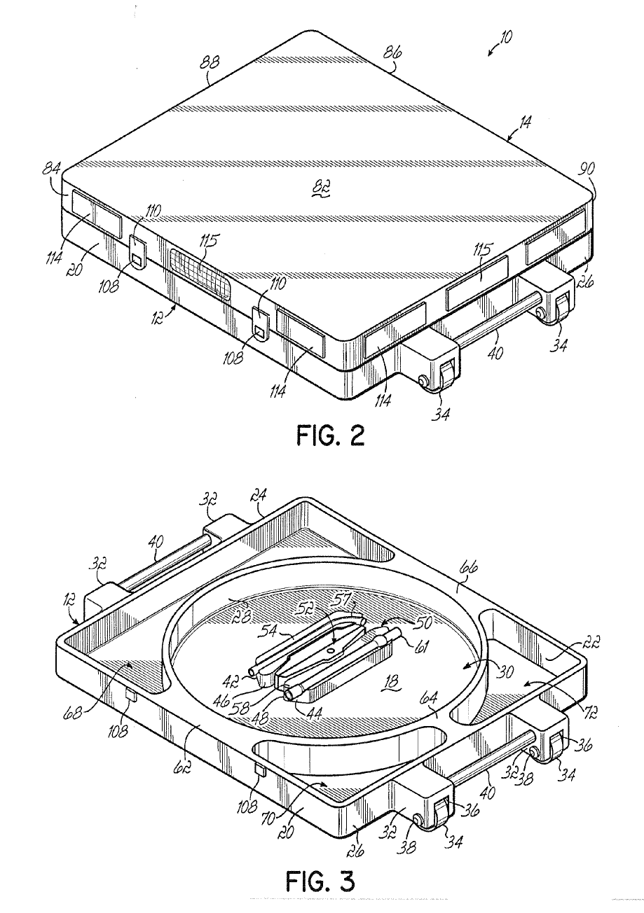

Container 10 further includes a pair of handles 40 that can be integrally formed with housing portions 12 and 14 and living hinge 16. As shown in FIGS. 1 and 2, each handle 40 extends between a pair of adjacent lugs 32. In the illustrative embodiment, each handle 40 is shaped as a substantially cylindrical rod. However, the handles 40 may assume a variety of other shapes.

First 42 and second 44 embossments extend upwardly from the floor 18 of the housing portion 12 and are integrally formed therewith, with embossments 42, 44 being disposed inward of rim 28 within the substantially cylindrical cavity 30. Embossment 42 includes a perimetrical edge 46 and embossment 44 includes a perimetrical edge 48. Embossments 42 and 44 are spaced apart from one another, and the configuration of edges 46 and 48 define a tool-receiving cavity 50 between the spaced apart embossments 42 and 44. More particularly, in the illustrative embodiment, cavity 50 is suitable for receiving a conventional scissors jack 52 as shown in FIGS. 3 and 4. Embossment 42 further includes an upper surface 54 with a tool-receiving cavity 56 formed therein. Cavity 56 may be operably effective for receiving a lug nut wrench 57, for instance. Embossment 44 also includes an upper surface 58, with a tool-receiving cavity 60 formed therein. Cavity 60 may be operably effective for receiving an extension 61 for use with jack 52. Storing jack 52, extension 61 and wrench 57 within container 10 assures the operator of having the necessary tools to mount a spare tire such as tire 80. Also, as shown in FIG. 4, embossments 42 and 44 are sized so that they, as well as jack 52, wrench 57 and extension 61 will fit below the hub area of spare tire 80, resulting in an economy of space within container 10.

The first housing portion 12 includes a connecting member 62 integral with and extending between rim 28 and front end 20 of housing portion 12 and a connecting member 64 extending between rim 28 and side 26. Also, the housing portion 12 includes a connecting member 66 connecting rim 28 and rear end 22. The connecting members 62, 64 and 66 in combination with floor 18, rim 28, front end 20, rear end 22 and sides 24, 26, define implement-receiving cavities 68, 70 and 72. Cavities 68, 70 and 72 are operably effective for receiving a variety of implements. For instance, as shown in FIG. 4, cavity 70 is used to hold a first aid kit 74 while cavity 72 is illustrated as receiving a flashlight 76 and a pair of flares 78.

Positioning the implement-receiving cavities 68, 70 and 72 outward of the rim 28 results in a further economy of space, since these spaces between the rim 28 and the ends and sides of first housing portion 12 would otherwise be unused. As may be appreciated, storing items such as first aid kit 74, flashlight 76 and flare 78 within container 10 will enhance the safety of an operator in need of mounting spare tire 80, if this procedure must be done at night and provides the assurance of having first aid equipment readily available if needed. Further in this regard, the spare tire container 10 can include one or more reflectors 114 (shown in FIGS. 1 and 2) secured to an external surface of one, or both, of the housing portions 12 and 14, by conventional means. Additionally, container 10 can include one or more lamps 115 (shown in FIG. 2 in lieu of one of the reflectors 114 shown in FIG. 1, for purposes of illustration) secured to one or both of the housing portions 12 and 14, by conventional means. For instance, each lamp 115 can be press fit into an aperture (not shown) formed in one of the housing portions 12 and 14.

The second housing portion includes a substantially planar top 82, a front end 84, rear end 86, and sides 88 and 90. A substantially cylindrical rim 92 extends downwardly from top 82 and, together with top 82, defines a substantially cylindrical, tire-receiving cavity 94. When the spare tire container 10 is in a closed position, as shown in FIG. 2, an upper surface of the rim 28 of the first housing portion 12 is proximate with a lower surface of the rim 92 of the second housing portion with the open tops of cavities 30 and 94 being disposed proximate one another so that tire 80 is substantially surrounded by rims 28 and 92 and is enclosed by container 10. The tire-receiving cavity is operably effective for receiving and enclosing a spare tire, such as tire 80, for use in a motor vehicle (not shown).

The second housing portion 14 includes a connecting member 96 extending between rim 92 and rear end 86, a connecting member 98 extending between rim 92 and side 90 and a connecting member 100 extending between rim 92 and front end 84. The connecting members 96, 98 and 100, together with top 82, rim 92, the front end 84, rear end 86 and sides 88 and 90, define implement-receiving cavities 102, 104 and 106. In the illustrative embodiment, cavities 102, 104 and 106 are configured substantially the same as cavities 68, 70 and 72, respectively. In this manner, an implement disposed in cavity 68 for instance, that has a height greater than side 24 of housing portion 12, may be partially disposed in the mating cavity 102 formed in the housing portion 14. However, correspondence between the implement-receiving cavities formed in the first housing portion 12 and the second housing portion 14 is not required.

As may be appreciated by reference to FIGS. 1 and 2, the spare tire container 10 may be latched in a closed position. In the illustrative embodiment, this is accomplished by male latching members or tabs 108 which engage female latching members 110 when container 10 is in a closed position. More particularly, tabs 108 extend through apertures 112 formed in the female latching members 110, when container 10 is in a closed position. Container 10 can also be latched in a closed position by a variety of other latching members.

FIG. 5 illustrates a spare tire container 150 according to an alternate embodiment of the present invention. Container 150 includes a first housing portion 152 and a second housing portion 154 which are hingedly connected via a living hinge 155. Housing portion 154 includes a downwardly extending protrusion 156 which is not included on container 10. Housing portion 156 is otherwise the same as housing portion 14 of container 10. The lower housing portion 152 includes a stepped recess 158 having an outwardly facing, upwardly extending surface 160 which is disposed in sealing engagement with the protrusion 156 when container 150 is in a closed position. The protrusion 156 and ledge 158 extend substantially around the perimeter of container 150 with the exception of local interruptions to accommodate lugs 32, latching tabs 108, female latching members 110 and living hinge 16. A variety of other sealing arrangements may be utilized with the spare tire container of the present invention.

FIG. 6 is a fragmentary cross-sectional view illustrating a portion of a spare tire container 170 according to another alternative embodiment of the present invention. Container 170 includes first 172 and second 174 housing portions which are the same as the housing portions 12 and 14 of container 10 except as subsequently described. The housing portions 172 and 174 are not connected by a living hinge, but instead are connected by a mechanical hinge indicated generally at 176. Hinge 176 includes a plurality of fingers 178 which are attached to the upper housing portion 174. Each finger 178 engages an aperture (not shown) formed in a generally horizontally extending member 180 integral with the lower housing portion 172.

FIG. 7 is a fragmentary view shown partially in cross-section and partially in perspective, illustrating a portion of a spare tire container 190 according to another alternative embodiment of the present invention. The container 190 includes a first, lower housing portion 192 and a second, upper housing portion 194 which are the same as the housing portions 12 and 14, respectively, of container 10 except as otherwise subsequently discussed. The housing portions 192 and 194 are not connected via a living hinge, unlike portions 12 and 14 of container 10. Instead, housing portions 192 and 194 are hingedly connected via a hinge 196, which is an alternative mechanical hinge as compared to the mechanical hinge 176 illustrated in FIG. 6 with respect to spare tire container 170. Hinge 196 includes a plurality of lower knuckles 198 integral with the lower housing portion 192 and a plurality of upper knuckles 199 integral with the upper housing portion 194. The knuckles 198 are interdigitated with knuckles 199. Each of the knuckles 198 and 199 may have a small recess (not shown) formed in one side and a similarly sized pin (not shown) formed in the other side so that the recesses and pins of knuckles 198 may engage the pins and recesses respectively, of the interdigitated ones of knuckles 199.

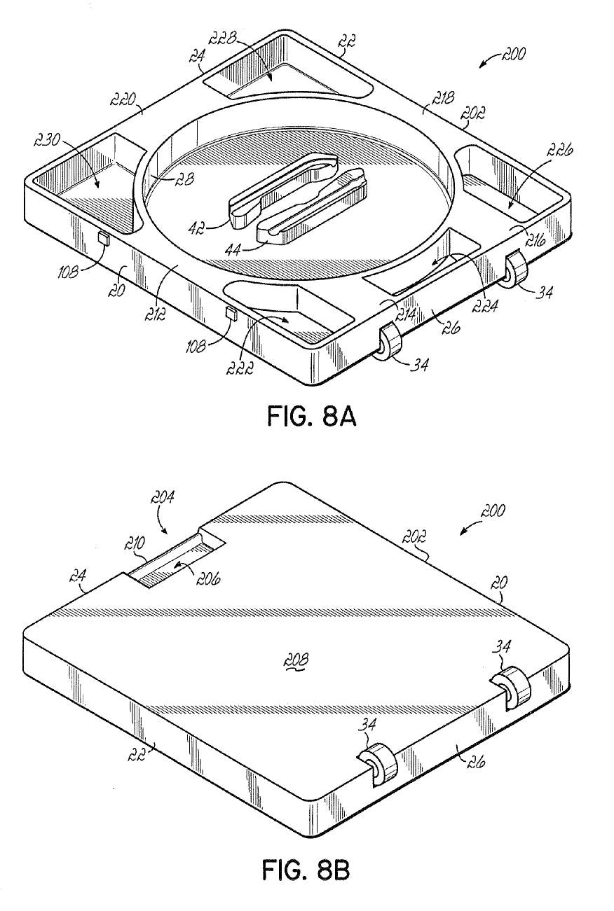

FIGS. 8A and 8B are perspective views illustrating a portion of a spare tire container 200 according to another alternative embodiment of the present invention. More particularly, FIGS. 8A and 8B illustrate a lower housing portion 202 of container 200, with the housing portion 202 illustrating additional variations that may be incorporated into the spare tire containers of the present invention. The spare tire container 200 and included housing portion 202 are the same as spare tire container 10 and included housing portion 12 except as otherwise noted in the subsequent discussion. Container 200 includes two of the wheels 34 rather than four of the wheels 34 which are included in container 10. Also, rather than being rotatably coupled to lugs 32, as shown with regard to spare tire container 10, the wheels 34 of container 200 are rotatably coupled to side 26 of housing portion 202. Another difference between containers 200 and 10 is that container 200 includes a single handle, indicated at 204 whereas container 10 includes two handles 40. The handle 204 includes a recess 206 formed in a floor 208 of housing portion 202 and a rounded portion 210. Recess 206 and rounded portion 210 combine to accommodate the fingers of a person's hand. As shown in FIG. 8B, the handle 204 is on the side opposite of wheels 34. In yet another alternative embodiment, a handle 204 may be incorporated on each side of the spare tire container, with the container including two pairs of wheels 34, with each handle 204 being disposed generally between one of the pairs of wheels 34. In that alternate embodiment, a pair of wheels 34 would be rotatably coupled to each of the sides 24 and 26.

Container 200 includes a rim 28, the same as container 10. However, container 200 includes connecting members 212, 214, 216, 218 and 220 interconnecting the rim 28 with the various sides and ends of container 200. This produces a different configuration of implement-receiving cavities disposed outward of rim 28, as compared to those of container 10. More particularly, container 200 includes implement-receiving cavities 222, 224, 226, 228 and 230. It should be understood that the implements that can be place in these cavities may or may not be tools. Like container 10, container 200 includes embossments 42 and 44 and the included tool-receiving cavities 50, 56 and 60.

While the foregoing description has set forth the preferred embodiments of the present invention in particular detail it must be understood that numerous modifications, substitutions and changes can be undertaken without departing from the true spirit and scope of the invention as defined by the ensuing claims. The invention is therefore not limited to specific embodiments as described, but is only limited as defined by the following claims.

What is claimed is:

1. A spare tire container comprising:
a first housing portion having a first tire-receiving cavity formed therein;
a second housing portion connected to said first housing portion, said second housing portion having a second tire-receiving cavity formed therein; and
a plurality of wheels rotatably coupled to one of said first and second housing portions.

2. A spare tire container as recited in claim 1, further comprising:
a mechanical hinge;
said first housing portion being hingedly connected to second housing portion by said mechanical hinge.

3. A spare tire container as recited in claim 1, wherein:
said plurality of wheels comprises a first pair of wheels and a second pair of wheels; and
said first and second pair of wheels being rotatably coupled to one of said first and second housing portions.

4. A spare tire container as recited in claim 3, further comprising:
a plurality of lugs, each of said lugs being integrally formed with and protruding from said one of said first and second housing portions; and
each of said wheels being rotatably coupled to one of said lugs.

5. A spare tire container as recited in claim 1, further comprising:
at least one handle, said at least one handle being integrally formed with one of said first housing portion and said second housing portion.

6. A spare tire container as recited in claim 1, further comprising:
at least one reflector, said at least one reflector being attached to an external surface of one of said first housing portion and said second housing portion; and
at least one lamp secured to one of said first housing portion and said second housing portion.

7. A spare tire container as recited in claim 1, further comprising:
at least one implement-receiving cavity formed in at least one of said first housing portion and said second housing portion.

8. A spare tire container as recited in claim 7, wherein:
said first housing portion is a lower portion of the spare tire container, said second housing portion is an upper portion of the spare tire container;
said lower portion includes a floor; and
said container further comprising a substantially cylindrical rim, said rim extending upwardly from said floor, said rim and said floor defining said first tire-receiving cavity.

9. A spare tire container as recited in claim 8, wherein:
said at least one implement-receiving cavity is disposed radially outward of said rim.

10. A spare tire container as recited in claim 8, wherein:
said implement-receiving cavity is a tool-receiving cavity and is disposed within said rim; and
said container further includes a pair of embossments, said embossments being integral with said floor and extending upwardly therefrom, said embossments being spaced apart from one another, each of said embossments including perimetrical edges, said edges being configured to define said tool-receiving cavity between said spaced apart embossments.

11. A spare tire container as recited in claim 1, wherein:
said first housing portion is in sealing engagement with said second housing portion when the spare tire container is in a closed position.

12. A spare tire container as recited in claim 1, wherein:
said first housing portion is a lower portion of the spare tire container and includes a floor and a substantially cylindrical first rim extending upwardly from said floor;
said first rim defining a perimeter of said first tire-receiving cavity, said floor closing said first tire-receiving cavity at one end thereof, said first tire-receiving cavity being open at an opposite end thereof;
said second housing portion is an upper portion of the spare tire container and includes a top and a substantially cylindrical second rim extending downwardly from said top;
said second rim defining a perimeter of said second tire-receiving cavity, said top closing said second tire-receiving cavity at one end thereof, said second tire-receiving cavity being open at an opposite end thereof; and
said first and second rims being proximate one another when the spare tire container is in a closed position whereby said first and second rims, said floor and said top are operably effective for substantially surrounding and enclosing a spare tire contained therein.

13. A spare tire container comprising:
a first housing portion having a first tire-receiving cavity formed therein;
a second housing portion having a second tire-receiving cavity formed therein;
a living hinge, said first housing portion being hingedly connected to said second housing portion by said living hinge;
a plurality of wheels rotatably coupled to one of said first and second housing portions; and
said first housing portion, said second housing portion and said living hinge being molded as a unitary construction.

14. A spare tire container as recited in claim 13, wherein:
said first tire-receiving cavity is substantially cylindrical;
said second tire-receiving cavity is substantially cylindrical; and
said first housing portion, said second housing portion and said living hinge are blow molded as a unitary construction.

15. A method of manufacturing a spare tire container for use on a motor vehicle comprising the steps of:
forming a first housing portion of the spare tire container, the first housing portion including a first tire-receiving cavity therein;
forming a second housing portion of the spare tire container, the second housing portion including a second tire-receiving cavity therein;
connecting the first and second housing portions to one another; and
rotatably coupling a plurality of wheels to one of the first and second housing portions.

16. A method as recited in claim 15, wherein:
forming the first housing portion comprises the step of blow molding the first housing portion; and
forming the second housing portion comprises the step of blow molding the second housing portion.

17. A method as recited in claim 15, wherein:
connecting the first and second housing portions to one another further comprises:
hingedly connecting the first and second housing portions to one another.

18. A method as recited in claim 15, wherein:
connecting the first and second housing portions to one another further comprises hingedly connecting the first and second housing portions to one another with a living hinge, said first housing portion, said second housing portion and said living hinge being integrally formed with one another as a unitary construction.

19. A method as recited in claim 15, wherein:
said first and second cavities are substantially cylindrical and the method further comprises:
forming at least one implement-receiving cavity in one of said first and second housing portions, and wherein forming at least one implement-receiving cavity includes positioning the implement-receiving cavity outward of the corresponding one of the first and second tire-receiving cavities.

20. A method as recited in claim 15, wherein:
said first and second cavities are substantially cylindrical and the method further comprises:
forming at least one tool-receiving cavity in one of said first and second housing portions, and wherein forming at least one tool-receiving cavity includes positioning the tool-receiving cavity within the corresponding one of the first and second tire-receiving cavities.
